(19) United States
(12) Patent Application Publication
(10) Pub. No.: US 2021/0392287 A1
(43) Pub. Date: Dec. 16, 2021

(54) CCD PHOTODETECTOR AND ASSOCIATED METHOD FOR OPERATION

(71) Applicant: Robert Bosch GmbH, Stuttgart (DE)

(72) Inventors: Alexander Greiner, Reichenbach (DE); Reiner Schnitzer, Reutlingen (DE); Siegwart Bogatscher, Leonberg (DE)

(21) Appl. No.: 17/279,371

(22) PCT Filed: Nov. 20, 2019
(86) PCT No.: PCT/EP2019/081924

§ 371 Date: Mar. 24, 2021

(30) Foreign Application Priority Data
Dec. 18, 2018 (DE) 10 2018 222 118.9

(51) Int. Cl. H04N 5/372; H04N 5/378; G01S 7/4863

(52) U.S. Cl. CPC H04N 5/37213; G01S 7/4863; H04N 5/378

(57) ABSTRACT

A CCD photodetector and an associated method for operation. A CCD photodetector for LIDAR systems is described, including a shift register including a plurality of consecutively situated register cells, including a first register cell and a last register cell, a loading line for loading the shift register, and a read-out amplifier for unloading the shift register, the loading line and the read-out amplifier each being connected to the first register cell. A corresponding method for operating a CCD photodetector is also described.

### FIELD

The present invention relates to a CCD photodetector and to an associated method for operation. In particular, the present invention relates to a CCD photodetector having reduced thermal noise, particularly suitable for LIDAR systems, and to a method for operating a CCD photodetector directed thereto.

### BACKGROUND INFORMATION

Light detection and ranging (LIDAR) systems will become established in the coming years for the implementation of highly automated driving functions. In the process, light is emitted into the surroundings of the system, and an exact copy of the surroundings is created from the reflected light. Charge-coupled device (CCD) photodetectors (abbrev.: CCDs) are used for the detection of the reflected light. In addition to a high sensitivity for the LIDAR radiation, the CCDs used in LIDAR systems must also enable a high frame rate, and have preferably low noise, due to the requirements placed thereon in this regard.

A CCD shall be understood to mean an image sensor including a plurality of photosensitive areas (pixels), in which the photo charges generated in an illumination phase are shifted pixel-by-pixel as charge packets, and transferred into a shift register as a buffer (cache) (so-called bucket-brigade circuit). After the shift register has been filled, the individual charge packets are converted, in the subsequent read-out phase, by an integrated read-out amplifier (transimpedance amplifier, or source follower (SE)) directly adjoining the shift register into a voltage signal which is proportional to the respective number of stored photo charges. The term of the amplifier is to be broadly interpreted, in particular still being referred to as a read-out amplifier in the case of amplification factors of less than or equal to 1.

Further electronic circuit elements may be connected downstream from the read-out amplifier, for example a circuit for noise suppression (correlated double sampling (CDS)) and an analog-to-digital converter circuit (A/D converter (A/D)). A combination of such circuit elements downstream from the shift register is generally referred to as a read-out electronic system. For particularly demanding applications, such as LIDAR, usually multiple read-out amplifiers are combined on the chip of the CCD, it being possible for at least one associated shift register to be exclusively connected upstream from each read-out amplifier. Accordingly, only a small portion of the total pixels of the CCD is then assigned to each shift register. In this way, the maximum dwell time in the shift register may be reduced, and thus also the frame rate increased, with the same read-out rate. In particular, a dedicated shift register may be assigned as a buffer to each individual active pixel of the CCD. The content of the shift register then typically corresponds to the temporal progress of the charge state of an individual pixel during the illumination phase. However, it is also possible, for example, to map the temporal progress of the charge state of multiple pixels in a shared shift register via a corresponding indication. In the case of a traditional CCD sensor, in contrast, only exactly one charge state is usually stored in each case in the shift register for a plurality of pixels. One disadvantage of CCDs under low light intensity conditions is their thermal noise, which may occur both in the photosensitive areas and in the shift registers. Due to the short dwell time (typically approximately 4 ns to 10 ns) of the generated charges in the photosensitive pixel, the thermal noise in these is usually negligible. In a shift register, however, the dwell time may be several 10 μs, which is why, depending on design, hundreds of, or even several thousand, thermal electrons may interfere with the signal during the read-out phase for register elements which are unloaded last into the read-out amplifier. Since in the case of applications in LIDAR systems thus far the most recently converted register elements typically include those signals having the greatest range, and equivalent thereto have the lowest signal, this has a particularly interfering effect and negatively affects the signal quality. The fundamental problem that the individual photo charges have differently long dwell times in the shift register, however, is independent of the application and, in the case of CCDs, generally results in differently strong noise components for the individual pixels.

### SUMMARY

According to the present invention, a CCD photodetector, an associated method for operation, as well as a corresponding LIDAR system, are provided.

A CCD photodetector according to an example embodiment of the present invention, in particular, the read-out unit of such a CCD photodetector, includes a shift register including a plurality of consecutively situated register cells, including a first register cell and a last register cell, a loading line for loading the shift register, and a read-out amplifier for unloading the shift register, the loading line and the read-out amplifier in each case being connected to the first register cell. In the process, it is not important to exactly establish the order of the register cells; rather, the first register cell and the last register cell in each case only denote an end of the shift register. What is essential for the present invention is that the loading line and the read-out amplifier are connected to the same end of the shift register. Connected means both connected to one another circuitry-wise (abstract) and electrically conductively (physical).

The loading line, the shift register, and the read-out amplifier preferably form a shared circuit plane. In the case of a three-dimensional design of the CCD chip, the loading line, however, may also lead out of a shared plane of the shift register and the read-out amplifier. The loading of the first register cell of the shift register may thus, in particular, take place both laterally within this plane and from directions from above or beneath this plane. The read-out amplifier preferably adjoins the longitudinal axis (i.e., along the row of the individual register cells) of the shift register.

A CCD photodetector is, in particular, understood to mean a detector array integrated completely on a (micro) chip, both the photosensitive areas (pixels) and the read-out amplifier (or the read-out electronic system) being situated on the chip as electronic components. The photo charges accumulated in the individual pixels during an illumination phase are incrementally (serially) transferred or (re)loaded into a shift register with the aid of charge coupling (bucket brigade) via a loading line. This may be a single shift register (including a loading line) for the entire CCD, or a dedicated shift register (including one loading line per shift register) that is assigned in each case to individual pixels or groups of pixels. The individual charges are then successively (serially) unloaded from the shift register in a read-out phase into an associated read-out amplifier.

The task of the read-out amplifier is to convert the individual charge packets from the register cells into a proportional voltage signal. The unloading of the shift register via the read-out amplifier thus results in a sequence of voltage pulses, it being possible, for example, for each individual voltage pulse to correspond, as a function of the circuit, to the temporal progress of the measured intensity at an individual pixel during an illumination phase. A shift register is made up of a chain of consecutively situated register cells, it being possible to shift (reload) the charges stored in the register cells between respective adjoining cells. Shift registers preferably have a linear design, but may also assume a curved shape. If a CCD includes multiple shift registers, these are preferably situated adjoining one another as rows situated next to one another (“grid column form”).

According to an example embodiment of the present invention, both the loading line and the read-out amplifier are in each case connected to a first register cell of the shift register. The loading and read-out directions, i.e., the running direction of the respective “bucket brigade,” of the shift register thus differ from one another (inverse read-out direction). As a result, from a processing view, during the illumination phase, both the loading of the shift register from the loading line via the first register cell, and the unloading of the shift register into the read-out amplifier, take place during the read-out phase via the first register cell. In other words, according to the present invention, the loading of the shift register from the loading line, and the unloading of the shift register into the read-out amplifier, take place via one and the same end of the shift register.

As a result, during the illumination or registration phase, the shift register is initially filled in one direction, and thereafter, in the read-out phase, the shift register is operated counter to the shift direction during the illumination phase. In the case of LIDAR applications, signals having a high range, and thus low signal levels, are thus read out first.

For these signals, the dwell time in the shift register is drastically reduced, by which fewer thermal noise electrons are collected.

In particular, for LIDAR applications, a CCD according to an example embodiment of the present invention may have several advantages compared to conventional CCDs.

A CCD according to an example embodiment of the present invention allows the temperature-dependent noise component to be considerably reduced. The CCD may thus be operated in a considerably larger temperature range, without losses in range, resolution and/or frame rate. This results in an increased maximum range, since even weak reflection signals from objects far away, which occur with a high time delay in relation to the emitted LIDAR signal, may still be detected. As an alternative, compared to current LIDAR systems, the necessary laser power may be reduced during the emission. Additional cooling of the detector is not required.

In the case of a CCD photodetector according to an example embodiment of the present invention, including multiple read-out amplifiers (and in each case one or multiple assigned shift register(s)), adjoining read-out amplifiers are preferably alternately connected to different ends of respectively assigned shift registers from shift registers situated next to one another. In the case of multiple assigned shift registers, the connection thus takes place in each case via the same register cell, i.e., via the same end of the shift register.

To achieve minimal noise in the case of lowest signal levels, the inverse read-out direction is thus combined with a CCD design, in which the shift registers or the read-out amplifiers are each alternately moved to the left and to the right. In this way, a higher number of read-out amplifiers per area is implementable, by which the dwell time of the signals in the shift register, and thus the thermal noise for the signals, may be further reduced.

A read-out amplifier is preferably connected to at least two shift registers situated next to one another. This has the advantage that shorter shift registers may be used. As a result, the number of shift processes necessary for unloading and the likelihood of reloading errors caused thereby are reduced.

The present invention furthermore relates to a LIDAR system, including a CCD photodetector, configured for carrying out a method. Such CCD photodetectors are particularly suitable for LIDAR applications due to the reduced thermal noise.

A further aspect of the present invention relates to a method for operating a CCD photodetector. A method according to an example embodiment of the present invention includes the provision of a read-out amplifier, including at least one assigned shift register including a plurality of consecutively situated register cells, which includes a first register cell and a last register cell, the loading of the shift register from a loading line via the first register cell during an illumination phase, and the unloading of the shift register into the read-out amplifier via the first register cell during a read-out phase. The CCD photodetector may, in particular, be a CCD photodetector according to the present invention.

In a method according to an example embodiment of the present invention, adjoining read-out amplifiers are preferably alternately connected to different ends of respectively assigned shift registers from shift registers situated next to one another. A read-out amplifier is preferably also connected to at least two shift registers situated next to one another. These features correspond to the specific embodiments of a CCD photodetector according to the present invention described above. The statements made in this regard directly also apply to the respective method.

For one specific embodiment of the present invention, in which a read-out amplifier is connected to at least two shift registers situated next to one another, the shift registers, during the read-out phase, are preferably alternately unloaded per register cell, or alternately in respective groups, made up of multiple register cells into the read-out amplifier. This means that the at least two shift registers associated with a read-out amplifier are not successively unloaded, but rather a serial reciprocal unloading takes place. In combination with the inverse read-out direction of the shift register, the effect of the thermal noise electrons on high-range targets may be further reduced in the case of LIDAR applications through such an alternating unloading of the shift registers into the read-out amplifier. This approach may be either directly alternate or be implemented in groups. In both instances, additional shift/memory registers may be used, or may be necessary, for the interim storage of the signals.

To be able to detect signals preferably efficiently and low-noise, in particular in the case of LIDAR applications, it is advantageous when read-out amplifiers, or downstream A/D converters, are used for the digitization on the CCD as much as possible. This considerably decreases the necessary storage time in the shift registers, resulting in lower thermal noise. However, more A/D converters may then be implemented in such systems than are actually required in terms of time (determined by the required frame rate). This, however, would result in a high peak power. During the read-out phase, an A/D converter connected to the read-out amplifier thus preferably alternately digitizes the charge packets present in the register cells, i.e., the proportional voltage pulses resulting after the read-out amplifier, on the rising edge and on the falling edge. The peak power may furthermore also be reduced in that a reduction of the bit depth of the A/D converter takes place at low signal levels of the read-out amplifier. With low signals, a power adaptation at the expense of the bit depth may thus be carried out.

Advantageous refinements of the present invention are disclosed herein.

### BRIEF DESCRIPTION OF THE DRAWINGS

Exemplary embodiments of the present invention are described in greater detail based on the figures and the description below.

FIG. 1 shows a schematic representation of a method for operating a CCD according to the related art.

FIG. 2 shows a schematic representation of a first specific embodiment of a method according to the present invention for operating a CCD.

FIG. 3 shows a schematic representation of a second specific embodiment of a method according to the present invention for operating a CCD.

FIG. 4 shows a schematic representation of a third specific embodiment of a method according to the present invention for operating a CCD.

FIG. 5 shows a schematic representation of a fourth specific embodiment of a method according to the present invention for operating a CCD.

### DETAILED DESCRIPTION OF EXAMPLE EMBODIMENTS

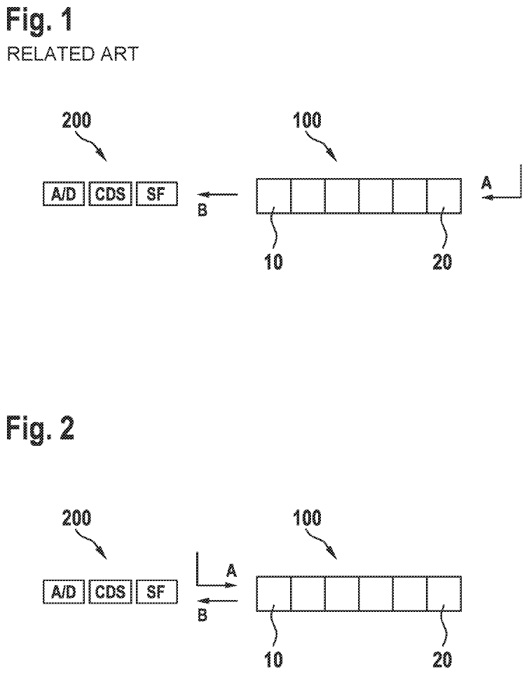

FIG. 1 shows a schematic representation of a method for operating a CCD according to the related art. A shift register 100 includes a plurality of consecutively situated register cells, including a first register cell 10 and a last register cell 20. In the related art, the loading of shift register 100 takes place from a loading line via last register cell 20 during an illumination phase A. In contrast, during a read-out phase B, the unloading of shift register 100 into read-out amplifier SF takes place via first register cell 10. The loading and read-out directions thus do not differ, i.e., the running direction of the respective “bucket brigade” remains the same in both phases. The individual charge packets are thus “pushed through” the shift register in one direction. Adjoining read-out amplifier SF, a noise suppressor CDS and an analog-to-digital converter A/D are additionally indicated. Together, they form a read-out electronic system 200.

FIG. 2 shows a schematic representation of a first specific embodiment of a method according to the present invention for operating a CCD. In contrast to the representation in FIG. 1, the loading of shift register 100 from a loading line takes place via first register cell 10 during an illumination phase A. The unloading of shift register 100 into read-out amplifier SF during a read-out phase B also takes place via first register cell 10. Adjoining read-out amplifier SF, a noise suppressor CDS and an analog-to-digital converter A/D are also additionally plotted as components of a read-out electronic system 200.

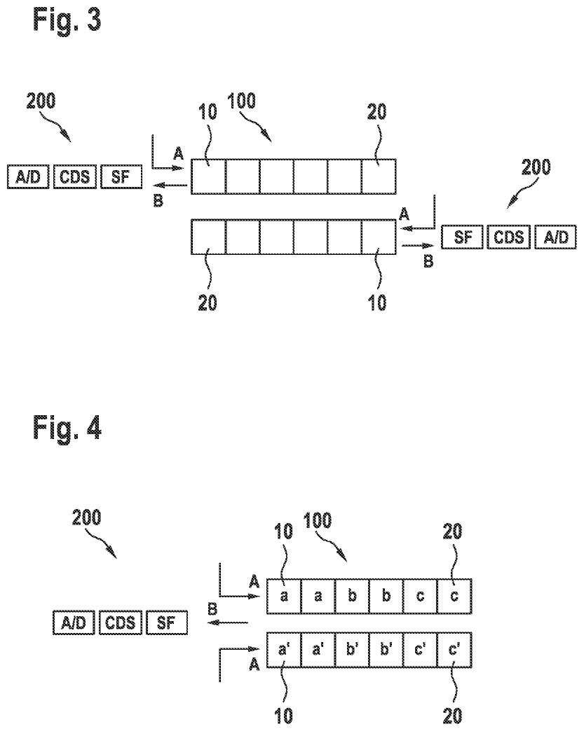

FIG. 3 shows a schematic representation of a second specific embodiment of a method according to the present invention for operating a CCD. Again, the loading of shift register 100 from a loading line, and the unloading of shift register 100 into read-out amplifier SF, take place via the same end of shift register 100. Adjoining read-out amplifiers SF are alternately connected to different ends of respectively assigned shift registers 100 from shift registers 100 situated next to one another. A corresponding CCD thus includes multiple read-out amplifiers SF including assigned shift registers 100, in the representation exactly one shift register 100 being assigned to a respective read-out amplifier SF. Such an offset arrangement of read-out amplifiers SF enables a higher integration density, and thus smaller, less noise-sensitive shift registers 100.

FIG. 4 shows a schematic representation of a third specific embodiment of a method according to the present invention for operating a CCD. The loading of shift register 100 from a loading line, and the unloading of shift register 100 into read-out amplifier SF again take place via the same end of the shift register. In this specific embodiment, a read-out amplifier SF is connected to at least two shift registers 100 situated next to one another. During read-out phase B, shift registers 100 are alternately unloaded in respective groups made up of multiple register cells aa, a′a′, bb, b′b′, . . . into read-out amplifier SF. In the representation, initially the first two register cells a of upper shift register 100 are unloaded in a first step, by way of example, into read-out amplifier SF, and thereafter the first two register cells a′ of lower shift register 100 are unloaded into read-out amplifier SF. This unloading is then continued accordingly with the next group of register cells b in upper shift register 100. As an alternative, shift registers 100 may also be alternately unloaded per register cell into read-out amplifier SF.

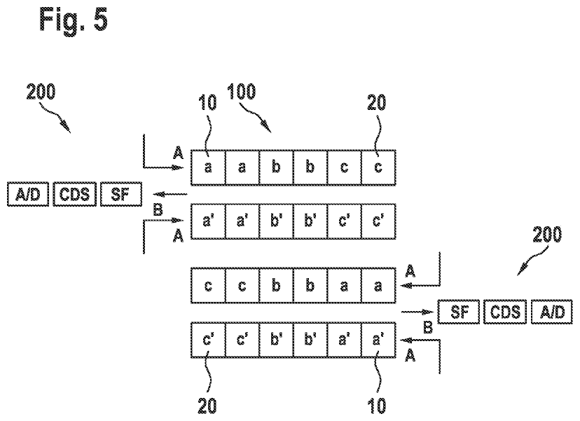

FIG. 5 shows a schematic representation of a fifth specific embodiment of a method according to the present invention for operating a CCD. This is a combination of the two above-described specific embodiments. In the representation, two adjoining read-out amplifiers SF are in each case connected to two assigned shift registers 100, read-out amplifiers SF alternately being connected to different ends of the respectively assigned two-of-four shift registers 100. During read-out phase B, shift registers 100 belonging to a read-out amplifier SF are alternately unloaded in respective groups made up of multiple register cells a, b, c; a′, b′, c′ into the associated read-out amplifier SF. As an alternative, in the process shift registers 100 may also be alternately unloaded per register cell into read-out amplifier SF.

1-9. (canceled)

10. A CCD photodetector, comprising:
a shift register including a plurality of consecutively situated register cells, the consecutively situated register cells including a first register cell and a last register cell;
a loading line for loading the shift register; and
a read-out amplifier for unloading the shift register, the loading line and the read-out amplifier each being connected to the first register cell.

11. The CCD photodetector as recited in claim 10, wherein adjoining read-out amplifiers are alternately connected to different ends of respectively assigned shift registers from shift registers situated next to one another.

12. The CCD photodetector as recited in claim 10, wherein a read-out amplifier is connected to at least two shift registers situated next to one another.

13. A method for operating a CCD photodetector, wherein a shift register assigned to a read-out amplifier includes a plurality of consecutively situated register cells, the consecutively situated register cells including a first register cell and a last register cell, the method comprising:
loading the shift register from a loading line via the first register cell during an illumination phase; and
unloading the shift register into a read-out amplifier via the first register cell during a read-out phase.

14. The method as recited in claim 13, wherein adjoining read-out amplifiers are alternately connected to different ends of respectively assigned shift registers from shift registers situated next to one another.

15. The method as recited in claim 13, wherein a first read-out amplifier is connected to at least two shift registers situated next to one another, and, during the read-out phase, the shift registers are alternately unloaded per register cell, or alternately in respective groups made up of multiple register cells, into the first read-out amplifier.

16. The method as recited in claim 13, wherein, during the read-out phase, an A/D converter connected to the read-out amplifier digitizes, alternately to a rising edge and to a falling edge, charge packets contained in the register cells.

17. The method as recited in claim 16, wherein a reduction of bit depth of the A/D converter occurs at low signal levels of the read-out amplifier.

18. A LIDAR system, comprising:
a CCD photodetector, wherein a shift register assigned to a read-out amplifier includes a plurality of consecutively situated register cells, the consecutively situated register cells including a first register cell and a last register cell, the CCD photodetector configured to:
load the shift register from a loading line via the first register cell during an illumination phase; and
unload the shift register into a read-out amplifier via the first register cell during a read-out phase.
